(19) United States
(12) Patent Application Publication
(10) Pub. No.: US 2025/0184362 A1
(43) Pub. Date: Jun. 5, 2025

(54) FEDERATED MINING METHOD AND SYSTEM FOR MULTIMODAL DATA BASED ON MULTIPLE SECURITY POLICIES

(71) Applicant: XUZHOU MEDICAL UNIVERSITY, Xuzhou (CN)

(72) Inventors: Xiang WU, Xuzhou (CN); Dianlei HU, Xuzhou (CN); Chuanchuan LU, Xuzhou (CN); Yongting ZHANG, Xuzhou (CN); Lili WANG, Xuzhou (CN)

(21) Appl. No.: 19/006,044

(22) Filed: Dec. 30, 2024

(30) Foreign Application Priority Data
May 22, 2024 (CN) 202410634652.4

(51) Int. Cl. H04L 9/40; G06F 40/279; G06V 10/82; G10L 25/51

(52) U.S. Cl. CPC H04L 63/20; H04L 63/126; G06F 40/279; G06V 10/82; G10L 25/51

(57) ABSTRACT

A federated mining method for multimodal data based on multiple security policies includes: a federated learning framework is used as a data mining model for distributed data mining; a multiple authentication mechanism is designed; a local edge node is selected to participate in a federated computation to obtain authenticated local edge node and aggregate a dataset; a multimodal data fusion and a multimodal data classification are performed on the dataset by a generalized multimodal data feature fusion model based on a multi-headed attention mechanism; and an adaptive perturbation mechanism based on cyclic correlation analysis and differential privacy is designed to add noise round by round and dynamically. A federated mining method for multimodal data is further provided.

### CROSS-REFERENCE TO RELATED APPLICATIONS

This application claims the benefit of priority from Chinese Patent Application No. 202410634652.4, filed on May 22, 2024. The content of the aforementioned application, including any intervening amendments thereto, is incorporated herein by reference in its entirety.

### TECHNICAL FIELD

This application relates to data security mining, more particularly to a federated mining method and system for multimodal data based on multiple security policies.

### BACKGROUND

Edge computing has become an important technological tool for multimodal data mining. Some existing studies show that completeness and availability of multimodal data provide data support for data mining in various industries. However, some studies have also found difficulties and problems in edge computing. For example, model robustness has been a key challenge to be addressed in edge computing. There are risks such as data theft, illegal access, tampering, lack of transparency of edge nodes, and other privacy disclosures during edge computing.

In order to cope with various security risks, security solutions based on anonymous authentication, differential privacy, encryption, access control, and identity authentication suitable for edge computing have been proposed. Although these privacy protection methods have specific edge computing privacy protection advantages, they still pose security threats in practical applications. For example, distributed anonymization methods usually create an anonymous region in a virtual location to protect the data of edge nodes. These methods are vulnerable to privacy attacks by attackers incorporating patients' background knowledge, leading to privacy disclosure.

In edge computing research that integrates differential privacy protection theory, the differential privacy protection method provides a generalized privacy protection framework for distributed machine learning. These noise interferences mainly increase the stochastic gradient descent process of machine learning. However, the objective functions in the study are mainly non-convex objective functions, which will increase the computational burden of the model, belong to local optimization, and affect data privacy security and utility. Meanwhile, in edge computing using fusion encryption methods, the models usually need to consume a large amount of computational cost, which increases the burden of model computation and reduces the efficiency of model training and usage. In addition, the access control and authentication are directly applied to edge computing, and too much reliance on trusted third parties increases the computation and storage costs of edge nodes and increases the risk of data leakage and management difficulties. Meanwhile, existing research ignores the quality and security screening and verification of edge nodes, which leads to the vulnerability of edge nodes to threats such as cloning attacks and key theft, which is a key obstacle to further research on edge computing applications.

Therefore, verifying the security of edge nodes and realizing secure access to the nodes is the key to improving security, as well as a hot issue in current research.

### SUMMARY

In view of the deficiencies in the prior art, this application provides a federated mining method for multimodal data and system based on multiple security policies. Technical solutions of this application are described as follows.

In a first aspect, this application provides a federated mining method for multimodal data based on a multi-security policy, comprising:
a multiple authentication mechanism, a generalized multimodal data feature fusion model based on a multi-head attention mechanism, and an adaptive perturbation mechanism based on cyclic correlation analysis and differential privacy;
wherein the federated mining method comprises the following steps:
(S1) using a federated learning framework as a data mining model for distributed data mining;
(S2) designing a multiple authentication mechanism; and selecting local edge nodes to participate in a federated computation to obtain authenticated local edge nodes and to aggregate a dataset;
(S3) performing multimodal data fusion and multimodal data classification on the dataset by a generalized multimodal data feature fusion model based on a multi-head attention mechanism; and
(S4) designing an adaptive perturbation mechanism based on cyclic correlation analysis and differential privacy to add noise round by round and dynamically.

In an embodiment, the multiple authentication mechanism is designed as follows.

First verification: before performing the federated computation, distributed edge nodes are credibly verified by using a lightweight verification method based on random forest; and nodes that pass verification can carry out local computation, and nodes that do not pass verification cannot carry out local computation; and

Second validation: after the local federated computation is finished, local model reputation evaluation S is computed, which is expressed as:

S=|F−E|

F represents F1_score, which is a commonly-used evaluation index for machine learning models; F1_score is a harmonic average of precision and recall rates of the model; E represents the error rate; and S∈[0,1]; the higher S value is, the better the performance of the model is; and local nodes are ranked in accordance with S value from the highest to the lowest, and the top 50% of local nodes are selected to participate in the model aggregation process.

In an embodiment, the nodes participating in the federated computation first undergo trusted verification. It is judged whether the number of nodes passing the trusted verification satisfies the condition: whether the number of nodes passing the trusted verification exceeds the current network maximum carrying capacity: if yes, the second node selection verification is carried out; otherwise, the second node selection verification is not carried out.

In an embodiment, the generalized multimodal data feature fusion model based on the multi-head attention mechanism comprises three parts: feature extraction, multimodal feature fusion based on a self-attention mechanism, and multimodal data classification based on the self-attention mechanism.

In an embodiment, the feature extraction comprises:

(1) Image features: key features of image data are extracted using a three-dimensional Convolutional Neural Network (3D-CNN) model. Firstly, the image is preprocessed by scaling, cropping, and normalization to meet input requirements of the 3D-CNN model. Secondly, the models of 3D convolutional layer, 3D pooling layer, normalization layer, normalization layer, activation layer and fully connected layer are constructed. Then, image sequence is taken as the input, and the spatio-temporal features of the image are effectively acquired by sliding the 3D convolution kernel. Then, the pooling layer is introduced to reduce the size of the feature image and the number of parameters, enhance the position invariance of the model, and improve the generalization ability of the model. Finally, through a series of convolutions, pooling and other operations, the target feature information that meets the research needs can be better extracted to express the basic structure and changes of the image, providing more accurate results for model prediction.

(2) Audio features: audio signal features are extracted by using an OpenSmile model. Firstly, the audio signal is preprocessed to meet the requirements of OpenSmile input data. Secondly, the configuration file is loaded to describe the time-domain features, frequency-domain features, filter bank features, advanced frequency-domain features, spectral correlation features, and to specify the set of to-be-extracted audio features and related parameters. Then, OpenSmile is used to automatically extract the audio features based on the relevant settings of the profile. Finally, the extracted audio features are stored in the specified format, where one row represents one sample, and one column represents one feature.

(3) Text features: text data features are extracted by Word2Vec. Firstly, a text corpus capable of storing large-scale text data is constructed. Secondly, the text data in the corpus is segmented using the Natural Language Toolkit (NLTK) tool, which segments the text into individual words or phrases, and further constructs a vocabulary list. The vocabulary list contains all non-repeated words, and each word is assigned with a unique identifier. Then, the Word2Vec model is trained to learn word vectors using the prepared participle data and the vocabulary list. During training, the model predicts the target word by words near the context or predicts the context word by the target word. After training, the trained Word2Vec model is used to extract word vector features from the text data. Finally, the word vectors of all words in the text data set are averaged or weighted to obtain feature representations of the entire text.

In an embodiment, the multimodal feature fusion method based on the self-attention mechanism is as follows.

(A) After the feature extraction is completed, the input N-dimensional modal data is simply spliced to splice the multimodal data into one piece of data.

The input N-dimensional modal data, after the completion of feature extraction, {X^{A}, X^{B}, . . . , X^{N}} corresponds to different modal data, and {d₁, d₂, . . . , d_{N}} is used to represent different modal data embeddings:

$$\begin{matrix}{X}^{A} = \{ {X}_{1}^{A} , {X}_{2}^{A} , … , {X}_{N}^{A} \} ∈ {R}^{( N * {d}_{a} )} \\ {X}^{B} = \{ {X}_{1}^{B} , {X}_{2}^{B} , … , {X}_{N}^{B} \} ∈ {R}^{( N * {d}_{b} )} \\ ⋮ \\ {X}^{N} = \{ {X}_{1}^{N} , {X}_{2}^{N} , … , {X}_{N}^{N} \} ∈ {R}^{( N * {d}_{N} )}\end{matrix} .$$

After splicing:

$$\begin{matrix}{X}^{fusion} = \{ {X}_{1}^{A} + {X}_{1}^{B} + ⋯ + {X}_{1}^{N} , … , {X}_{N}^{A} + {X}_{N}^{B} + ⋯ {X}_{N}^{N} \} \\ {X}^{fusion} ∈ {R}^{N * ( {d}_{a} + {d}_{b} + ⋯ + {d}_{N} )}\end{matrix} .$$

In the fully connected layer, d_{fusion}=dₐ+d_{b}+ . . . +d_{N}; F_{fusion}∈R^{n·d}^{_{fusion}};

$${F}_{fusion} = {W}_{fusion} {X}^{fusion} + b .$$

In the above formula, F represents output; W represents weight; X represents input, and b represents bias.

Q, K, and V represent the parameters of the linear projection layer. It should be noted that Q, K, and V represent the parameter matrices Query, Key, and Value within the attention mechanism. The input sequences are passed through three different linear transformation layers to obtain the Query, Key, and Value matrices, respectively. Q, K, and V are expressed in terms of the self-attention mechanism as follows:

$$\begin{matrix}Q = [ {Q}_{1} , {Q}_{2} , … , {Q}_{N} ] ∈ {R}^{N * {d}_{fusion}} \\ K = [ {K}_{1} , {K}_{2} , … , {K}_{N} ] ∈ {R}^{N * {d}_{fusion}} \\ V = [ {V}_{1} , {V}_{2} , … , {V}_{N} ] ∈ {R}^{N * {d}_{fusion}}\end{matrix} .$$

(B) Computation of correlation scores: for each position in the data sequence, the correlation score between one position and other positions in the data sequence is computed. The correlation is usually calculated using dot product, scaled dot product or bilinear function.

The similarity relationship between the data is defined as r. The similarity between the data can be calculated by parameters Q and K, which is expressed as:

$$r = \frac{{QK}^{T}}{\sqrt{{d}_{K}}} .$$

(C) Weight assignment: the correlation scores are normalized by Softmax to obtain the attention weights of each position relative to the other positions. These weights indicate the dependence degree of the model on other positions when generating the current position representation.

Defining the correlation weights of the Q and K parameters as wᵢⱼ, the correlation weights of these two features can be calculated using the softmax function as follows:

$${w}_{ij} = soft max ( \frac{{QK}^{T}}{\sqrt{{d}_{K}}} ) .$$

Where Q and K are the parameter matrices; and dx represents the dimension of a matrix K.

(D) Weighted summation: the calculated attention weights are used to weight and sum the representations of all positions to obtain the final self-attention representation. This representation will take into account the information of each position in the entire input sequence and assign different weights according to the importance.

The final feature of the multimodal data is expressed as:

$${Z}_{fusion} = Attention ( QKV ) = {w}_{ij} V$$

(E) The data features are performed with dimensionality reduction according to the calculated weights, and the primary features are retained to complete the multimodal data fusion.

In an embodiment, the multimodal data classification is designed as follows: data from edge nodes are classified using a multilayer perceptron (MLP).

In an embodiment, the adaptive perturbation mechanism based on cyclic correlation analysis and differential privacy is designed as follows:

A set of random training samples Dᵢ in D is used for training. The total correlation value between i parameters during parameter download is expressed as:

$${Rel}_{i} ( D ) = {\sum }_{j = 1} {Rel}_{ij} ( D ) .$$

The average value of the correlation analysis results is expressed as:

$${Rel}_{i} ( {D}_{i} ) = \frac{1}{N} {\sum }_{j = 1} {Rel}_{ij} ( D ) .$$

It should be noted that D represents the total dataset; Dᵢ represents the subset of random samples in D; j represents the number of training rounds in the range [1, 1]; i represents the parameter in the range [0, N]; N represents the total number of parameters; Rel represents the correlation computation function, including but not limited to the Pearson correlation analysis function.

The current parameter set is performed with differential privacy protection according to the correlation, and Gaussian noise is used to add noise processing, and the stronger the correlation is, the smaller the Gaussian noise is.

The correlation coefficient ρ is expressed as:

$${ρ}_{i} = \frac{1}{{Rel}_{i} ( {D}_{i} )} .$$

The noise & is expressed as:

$${ε}_{i} = {ρ}_{i} \times ε .$$

ε is a noise value, and ε∈(0,1).

In a second aspect, this application further provides a federated mining system for multimodal data comprising:
a memory;
a processor; and
a computer program;
wherein the computer program is stored in the memory and executed on the processor; and the processor is configured to execute the computer program to implement the above-described federated mining method for multimodal data.

Compared to the prior art, this application has the following beneficial effects.

This application reduces the training cost by designing a multiple authentication mechanism for federated learning edge nodes to select secure sub-models.

This application proposes a multimodal data feature fusion method based on a multi-head attention mechanism as a generalized model for multimodal data computation, thereby reducing the computational burden.

This application introduces an adaptive perturbation mechanism based on circular correlation analysis, which can dynamically adjust the range of added noise by adding a small amount of noise to model parameters with high correlation and a small amount of noise to model parameters with low correlation.

Of course, technical solutions of this application do not necessarily need to achieve all the advantages described above at the same time.

### BRIEF DESCRIPTION OF THE DRAWINGS

In order to illustrate the technical solutions in the embodiments of the present disclosure more clearly, the drawings required in the description of the embodiments will be briefly described below. Obviously, presented in the drawings are merely some embodiments of the present disclosure, which are not intended to limit the disclosure. For those skilled in the art, other drawings may also be obtained according to the drawings provided herein without paying creative efforts.

FIG. 1 shows a flow diagram of a federated mining method for multimodal data based on multiple security policies according to one embodiment of the present disclosure;

FIGS. 2A-2C show results of ablation experiments with and without an attention mechanism in a bimodal state;

FIGS. 3A-3C show results of ablation experiments with and without an attention mechanism in a trimodal state;

FIGS. 4A-4C show results of ablation experiments with and without noise in the bimodal state;

FIGS. 5A-5C show results of ablation experiments with and without noise in the trimodal state;

FIGS. 6A-6E show performance comparison results of feature fusion models in the bimodal state;

FIGS. 7A-7E show performance comparison results of feature fusion models in the trimodal state; and

FIGS. 8A-8B show comparison results of screening efficiency of sub-models.

### DETAILED DESCRIPTION OF EMBODIMENTS

The technical solutions in the embodiments of the present disclosure will be clearly and completely described below in conjunction with the accompanying drawings of the present disclosure. Described below are merely some embodiments of the disclosure, which are not intended to limit the disclosure. For those skilled in the art, other embodiments obtained based on these embodiments without paying creative efforts should fall within the scope of the disclosure.

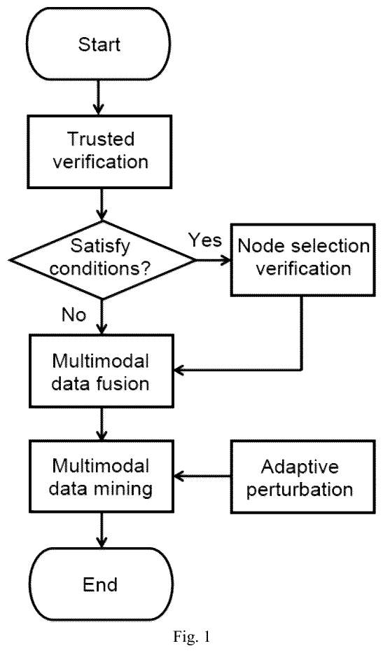

In order to reduce the computational burden of the model, and to verify the security of the edge nodes and realize the security of the access to the edge nodes is a hot issue in the current research. In order to solve the above-mentioned technical problems, referring to FIG. 1, the present disclosure provides a federated mining method for multimodal data based on a multi-security policy.

Referring to FIG. 1, the federated mining method for multimodal data based on the multi-security policy includes a multiple authentication mechanism, a generalized multimodal data feature fusion model based on a multi-head attention mechanism, and an adaptive perturbation mechanism based on cyclic correlation analysis and differential privacy. The method specifically includes the following steps (S1)-(S4).

(S1) A federated learning framework is used as a data mining model for distributed data mining.

(S2) The multiple authentication mechanism is designed, and local nodes are selected to participate in the federated computation to obtain authenticated local edge nodes and aggregate the dataset.

The multiple authentication mechanism is designed as follows.

First verification: before the start of the federated computation, distributed edge nodes are credibly verified by using a lightweight verification method based on random forest; and nodes that pass the verification can perform local computation, and nodes that do not pass the verification cannot perform local computation.

Second validation: after the local federated computation is finished, the value of local model reputation evaluation S is computed, which is expressed as:

S=|F−E|

F represents F1_score, which is a commonly-used evaluation index for machine learning models; F1_score is a harmonic average of precision and recall rates of the model; E represents the error rate; and S∈[0,1]; the higher S value is, the better the performance of the model is; and local nodes are ranked in accordance with S value from the highest to the lowest, and the top 50% of local nodes are selected to participate in the model aggregation process.

The nodes participating in the federated computation first undergo trusted verification. It is judged whether the number of nodes passing the trusted verification satisfies the condition: whether the number of nodes passing the trusted verification exceeds the current network maximum carrying capacity: if yes, the second node selection verification is carried out; otherwise, the second node selection verification is not carried out.

(S3) The local nodes passing the validation are performed with multimodal data fusion and classification by using the designed generalized multimodal data feature fusion model based on the multi-head attention mechanism.

The generalized multimodal data feature fusion model based on the multi-head attention mechanism includes three parts: feature extraction, multimodal feature fusion based on the self-attention mechanism, and multimodal data classification.

Specifically, feature extraction includes:

Image features: key features of image data are extracted using the 3D-CNN model.

Audio features: audio signal features are extracted using the OpenSmile model; and the extracted audio signal features are stored in a specified format.

Text features: text data features are extracted by Word2Vec.

In this embodiment, the multimodal feature fusion method based on the self-attention mechanism is as follows.

(a) After the feature extraction is completed, the input N-dimensional modal data is simply spliced to splice the multimodal data into one piece of data.

(b) Computation of correlation scores: for each position in the data sequence, the correlation score between one position and other positions in the data sequence is computed.

(c) Weight assignment: the correlation scores are normalized by Softmax to obtain the attention weights of each position relative to the other positions.

(d) Weighted summation: the calculated attention weights are used to weight and sum the representations of all positions to obtain the final self-attention representation.

(e) The data features are performed with dimensionality reduction according to the calculated weights, and the primary features are retained to complete the multimodal data fusion.

Specifically, the multimodal data classification is designed: using the multilayer perceptron to classify data from edge nodes.

(S4) In addition, the adaptive perturbation mechanism based on cyclic correlation analysis and differential privacy is designed to add noise round by round and dynamically.

The adaptive perturbation mechanism based on cyclic correlation analysis and differential privacy is designed as follows.

The correlation between the upload and download parameters and the calculation results in each round is calculated. The parameters in the current parameter set are protected with differential privacy according to the correlation, and noise is added by Gaussian noise.

In an embodiment, based on the same inventive conception as the above-described method, a federated mining system for multimodal data based on a multi-security policy is also provided. The federated mining system includes a memory, a processor, and a computer program. The computer program is stored in the memory and runs on the processor. When executing the computer program, the processor implements the above-described federated mining method for multimodal data.

### Embodiment 1

Ablation Experiment with and without the Attention Mechanism

In order to verify the performance of the proposed federated mining method for multimodal data based on multiple security policies, ablation experiments were performed on bimodal and trimodal datasets.

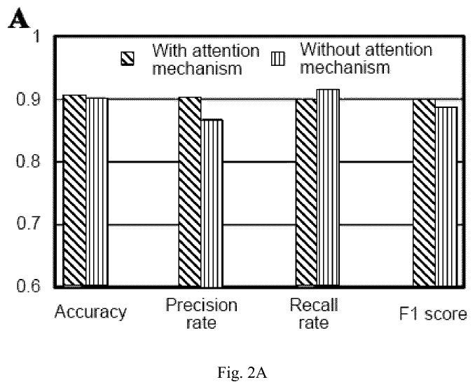

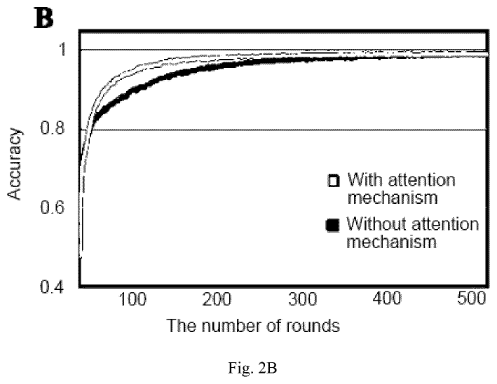

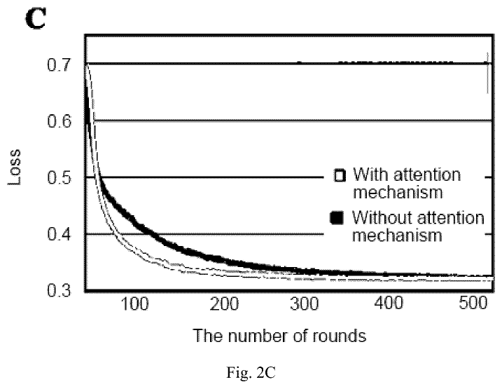

FIGS. 2A-2C showed experimental results of the proposed method in a bimodal Parkinson disease dataset. As shown in FIG. 2A, the experimental results showed that the proposed method had relatively low recall rate; its accuracy, precision rate, and F1 score were all higher than those of the experiment without adding the attention mechanism; and the proposed method had better performance in fusing features from speech and gait bimodal data.

FIGS. 2B-2C showed that when the number of iterations reached 500, the accuracy of the proposed method increased rapidly and tended to be stable as the number of iterations increased. Meanwhile, the loss value decreased rapidly and tended to be constant.

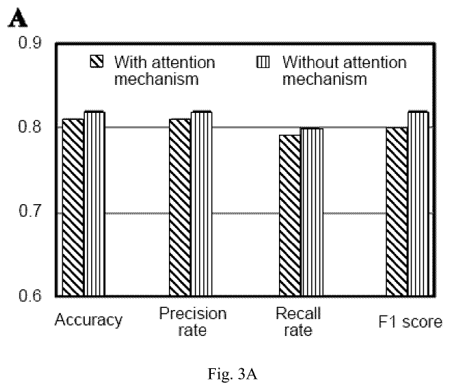

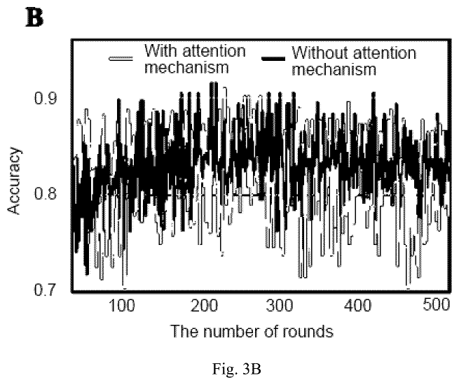

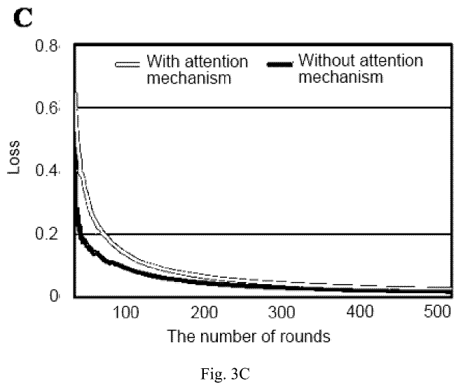

The comparison experimental results of the proposed method on the trimodal CMU-MPSEI dataset were shown in FIGS. 3A-3C. It could be obtained from FIG. 3A that affected by the size of the multimodal federated computation framework, the accuracy of the proposed method for trimodal feature fusion was similar to that of the model with the attention mechanism. It could be obtained from FIGS. 3B-3C that as the iteration period increased, the accuracy of the trimodal feature fusion model with the attention mechanism converged rapidly, and the loss value decreased and converged rapidly. The ablation experiments showed that the bimodal and trimodal feature fusion models with the fusion attention mechanism outperformed those models without the fusion mechanism.

### Embodiment 2

Ablation Experiments with and without Noise

In order to verify the performance of the proposed method under noise perturbation, bimodal and trimodal ablation experiments with and without noise perturbation were performed.

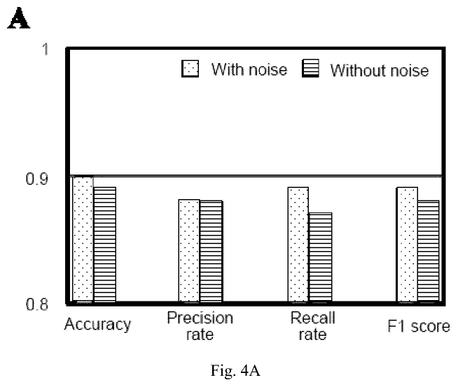

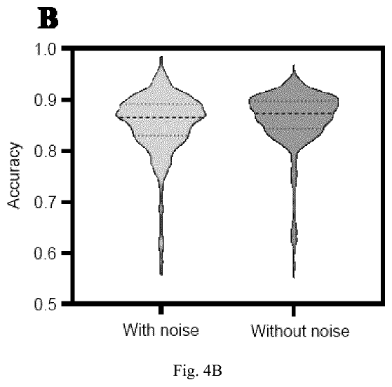

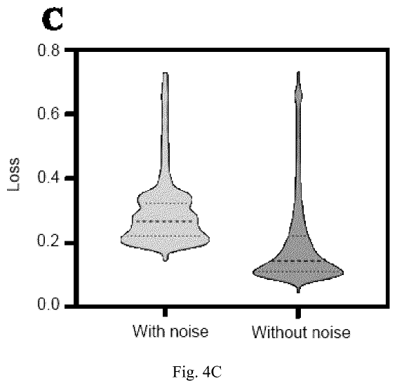

FIGS. 4A-4C showed noise perturbation results of the proposed method applied to the bimodal Parkinson dataset. As shown in FIG. 4A, dynamic adaptive Gaussian noise perturbation is added to the proposed method to change the distribution of the data, so that the data and the corresponding distribution are disturbed for privacy preservation. The experimental results showed that the accuracy, precision rate, recall rate, and F1 scores of the two modal models were higher than those of the benchmark method, indicating that the dynamic adaptive noise perturbation mechanism based on correlation analysis ensured the robustness of the noise-added model to a certain extent.

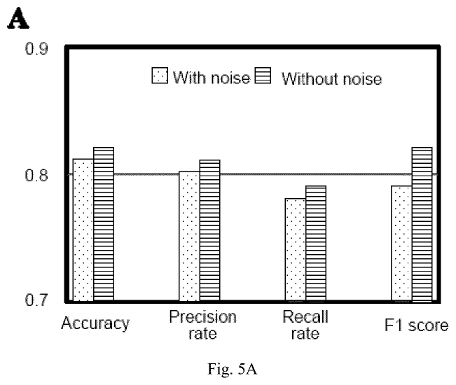

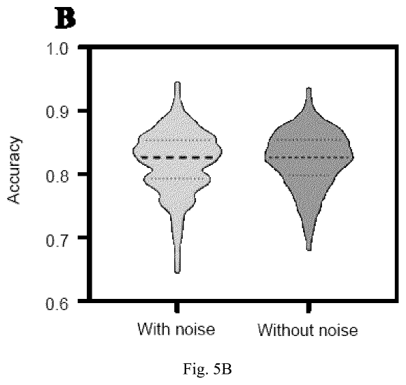

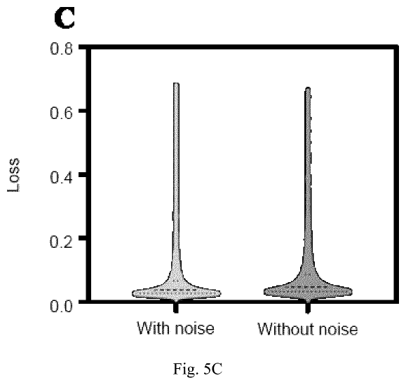

FIG. 5A showed the noise perturbation results of the trimodal dataset CMU-MPSEI applied to the proposed method. Due to the large model size and number of levels, all the indexes of the proposed method in the trimodal model with noise were slightly lower than the model without noise. In FIGS. 4B-4C and FIGS. 5B-5C, the loss value after noise perturbation slightly decreased, which was slightly higher than that of the model without noise perturbation, but higher accuracy could be guaranteed. Meanwhile, from the data density of the width response in the figure, the accuracy of the model with the noise mechanism during the training process was concentrated in the median. In contrast, the models without noise were concentrated in the upper quartile. As could be seen in the tail-width plot, the model without noise was trained and fitted faster than the model with added noise, and the loss also decreased faster. The ablation experiments showed that the bimodal intelligence model with noise added had significant feature fusion and optimization advantages.

### Embodiment 3

### Comparative Experiments of Multimodal Feature Fusion Models

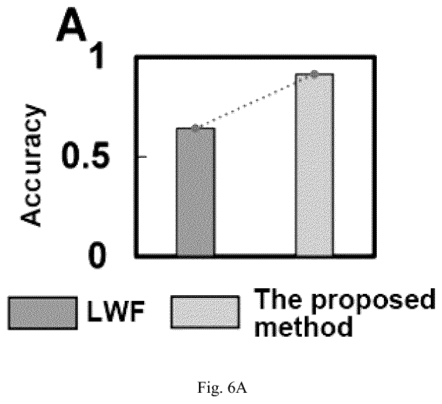

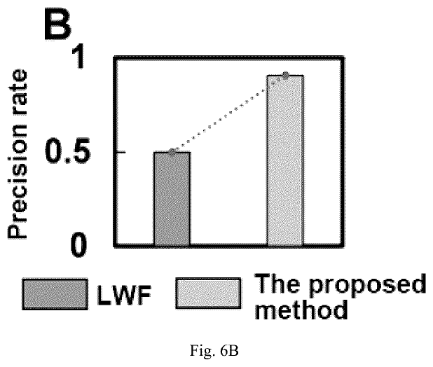

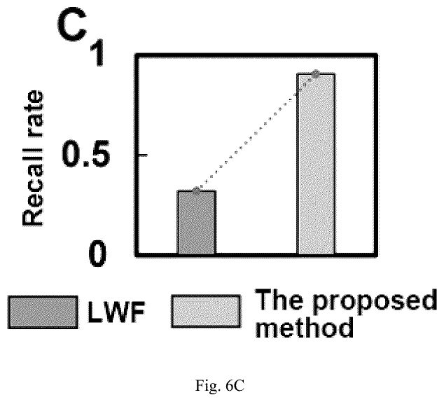

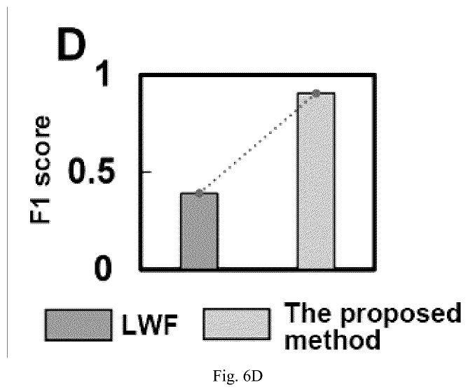

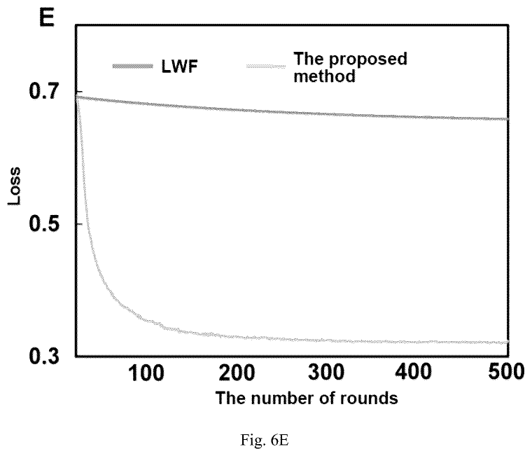

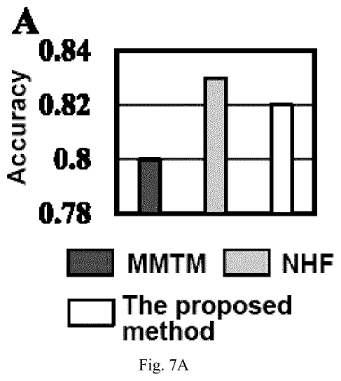

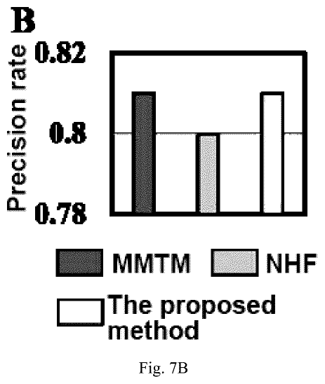

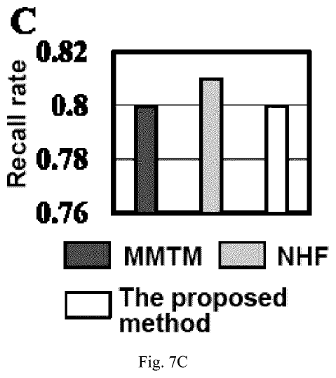

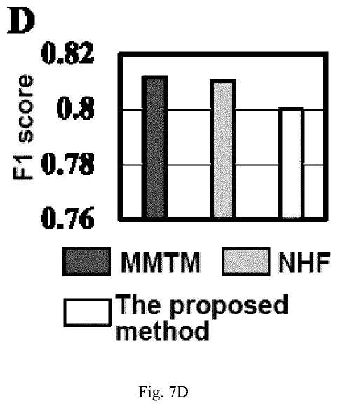

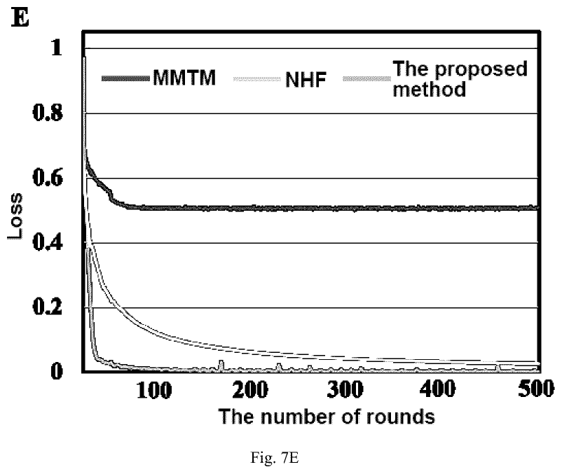

In order to evaluate the performance of the multimodal feature fusion model with the attention mechanism, the multimodal feature fusion model with the attention mechanism was compared to the Low-rank Multimodal Fusion (LWF) that added the attention mechanism. The comparison results were shown in FIGS. 6A-6E and FIGS. 7A-7E.

FIGS. 6A-6E showed the comparison results between the proposed method and the LWF model in the bimodal dataset. The training parameters of the LWF model were the same as those of the proposed method. FIGS. 6A-6D showed the simulation results regarding the comparison indexes of accuracy, precision rate, recall rate and F1 score. In addition, FIG. 6E showed the loss curves for the comparison methods. FIG. 6A showed the accuracy of the proposed method was almost 30% higher than that of the benchmark method. FIG. 6B showed the precision rate of the proposed method was nearly 40% higher than that of the benchmark method. FIGS. 6D-6E showed that the F1 score of the proposed method was nearly 50% higher than the LWF, and the loss value decreased rapidly and started to converge after about 200 iterations. Higher recall rate meant that the model would make fewer incorrect judgments on samples that were actually positive, and the probability of missing judgments would be lower. The higher the accuracy was, the better the prediction effect of the model was. The “positive” and “negative” indicated the true value of the sample. Positive samples were positive samples, belonging to the basics of machine learning. Recall rate measures the proportion of positive samples that were correctly identified as positive.

FIGS. 7A-7E showed the comparison results between the proposed method, Multi-modal Transfer Module (MMTM) and Non-homogeneous fusion (NHF) in the trimodal dataset CMU-MPSEI. The same parameters were set for the three modeling frameworks. The detailed comparison results of accuracy, precision rate, recall rate and F1 score were shown in FIGS. 7A-7D. The loss curves of the three methods were shown in FIG. 7E.

The results showed that the overall performance of the proposed method was more stable, and the training loss value decreased and converged rapidly, which was significantly better than MMTM and NHF; and the proposed method has better model prediction and data fitting. The above comparative analysis showed that the proposed method could effectively and accurately realize multimodal feature fusion in bimodal Parkinson disease dataset and trimodal CMU-MPSEI dataset.

### Embodiment 4

### Comparative Experiment of Sub-Model Screening Efficiency

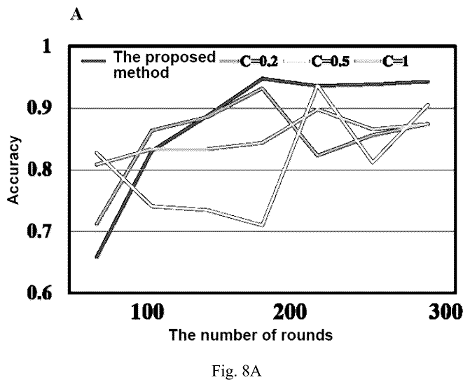

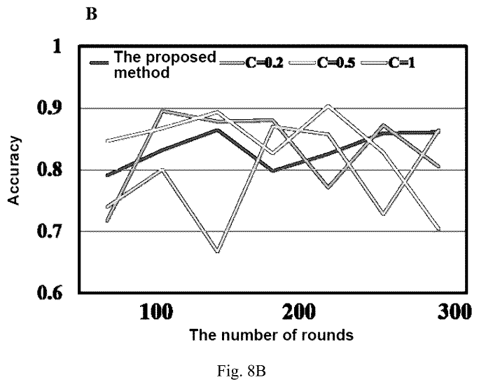

In order to verify the performance of the proposed method under sub-model screening, experiments were conducted on bimodal and trimodal datasets. The experimental results were shown in FIGS. 8A-8B below.

In order to ensure the quality of large-scale edge nodes under the federated learning framework and to reduce the security threat of low-quality edge nodes, this disclosure adopted the round-by-round correlation analysis method to screen the sub-models. Compared with the traditional method, the round-by-round iterative sub-model selection and parameter updating method were more suitable for the multimodal federated computing framework. FIGS. 8A-8B showed the performance of the round-by-round correlation analysis method applied to bimodal and trimodal datasets, respectively.

In the traditional federated learning sub-model filtering method, C was the key parameter indicating that the edge nodes were filtered according to a certain probability. Experiments were conducted to compare the filtering probabilities of 0.2, 0.5, and 1 in common sub-models with the proposed bimodal and trimodal sub-model filtering methods based on round-by-round correlation analysis.

This disclosure analyzed the commonly used sub-models with client screening probabilities C=0.2, C=0.5 and C=1 with the proposed bimodal and trimodal sub-model screening methods.

The experimental results showed that the higher the value of C was, the higher the accuracy was. However, the number of edge nodes that needed to upload parameters also increased, and the communication loss between the local model and central model also increased. Therefore, selecting an appropriate C was a practical model optimization scheme. However, the accuracy of the proposed method from the beginning of the iteration was higher than that of the conventional method, because the method could select the appropriate model to participate in uploading the parameters by the round-by-round iteration accuracy and response delay function.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A federated mining method for multimodal data based on multiple security policies, comprising:
(S1) providing a federated learning framework as a data mining model for distributed data mining;
(S2) providing a multiple authentication mechanism; and selecting a local edge node to participate in a federated computation to obtain an authenticated local edge node and to aggregate a dataset;
(S3) performing a multimodal data fusion and a multimodal data classification on the dataset by a generalized multimodal data feature fusion model based on a multi-head attention mechanism;
(S4) providing an adaptive perturbation mechanism based on cyclic correlation analysis and differential privacy to add noise round by round and dynamically;
wherein in step (S2), the multiple authentication mechanism is provided through steps of:
before performing the federated computation, performing a trusted verification on a distributed edge node by a lightweight verification method based on random forest;
if the distributed edge node is trusted, a local federated computation will be performed on the distributed edge node;
if the distributed edge node is not trusted, the local federated computation cannot be performed on the distributed edge node;
after performing the local federated computation, computing a local model reputation evaluation S, expressed as:
$$S = \vert F - E \vert ;$$
F represents F1_score, which is a harmonic average of a precision rate and a recall rates of a model; E represents an error rate; and S∈[0,1];
wherein the generalized multimodal data feature fusion model based on the multi-head attention mechanism comprises feature extraction, multimodal feature fusion based on a self-attention mechanism, and multimodal data classification based on the self-attention mechanism;
wherein the multimodal feature fusion method based on the self-attention mechanism is performed through steps of:
(a) after the feature extraction, inputting N-dimensional modal data to splice multimodal data into a data sequence;
(b) calculating correlation scores between different positions in the data sequence;
(c) performing Softmax normalization on the correlation scores to obtain attention weights between different positions in the data sequence;
(d) obtaining a final self-attention representation by using calculated attention weights to weight and sum representations of all positions in the data sequence;
(e) performing data feature dimensionality reduction based on the calculated attention weights, retaining primary features, and completing the multimodal data fusion;
wherein the adaptive perturbation mechanism based on cyclic correlation analysis and differential privacy is performed through steps of:
calculating a correlation between upload and download parameters and a calculation result in each round; and
protecting parameters in a current parameter set with differential privacy according to the correlation, and adding noise by Gaussian noise.

2. The federated mining method of claim 1, wherein the trusted verification is performed on the local edge node participating in the local federated computation;
it is judged whether the number of local edge nodes passing the trusted verification exceeds a current maximum carrying capacity of a network; and
if so, a node selection verification is performed; otherwise, the node selection verification is not performed.

3. The federated mining method of claim 1, wherein the feature extraction comprises:
extracting a key feature of image data by using a three-dimensional Convolutional Neural Network (3D-CNN) model;
extracting an audio signal feature by using an OpenSmile model; and storing the extracted audio feature in a specified format; and
extracting a text data feature by using a Word2Vec model.

4. The federated mining method of claim 1, wherein the multimodal data classification is performed by classifying the dataset by using a multilayer perceptron.

5. A federated mining system for multimodal data, comprising:
a memory;
a processor; and
a computer program;
wherein the computer program is configured to be stored in the memory; and the processor is configured to execute the computer program to implement the federated mining method of any one of claims 1-4.
